(19) United States
(12) Patent Application Publication
(10) Pub. No.: US 2023/0419434 A1
(43) Pub. Date: Dec. 28, 2023

(54) PERSONALIZED ADAPTIVE EDUCATION COURSE ADAPTING TO NEURODIVERSITY CONSIDERATIONS IN ONLINE LEARNING

(71) Applicant: International Business Machines Corporation, Armonk, NY (US)

(72) Inventors: Martin G. Keen, Cary, NC (US); Christopher John Rayns, Siler city, NC (US); Makenzie Manna, Poughkeepsie, NY (US); Kriti Kamra, Markham (CA)

(21) Appl. No.: 17/808,324

(22) Filed: Jun. 23, 2022

(51) Int. Cl. G06Q 50/20

(52) U.S. Cl. CPC G06Q 50/2053; G06N 20/00

(57) ABSTRACT

In an approach for tailoring a set of course material of an online educational course to provide one or more learning supports necessary for a student with a neurodivergent-classified condition to succeed, a processor receives a request from a user to tailor the set of course material. A processor identifies one or more neurodivergent needs of the user based on a first set of data gathered from a database. A processor observes the user complete an unmodified version of the online educational course in real-time to identify one or more additional neurodivergent needs of the user. A processor determines one or more preferences of the user. A processor generates a set of recommendations on how to tailor the set of course material. A processor creates a personalized user interface based on the set of recommendations for the user to access a tailored set of course material.

### BACKGROUND OF THE INVENTION

The present invention relates generally to the field of data processing, and more particularly to a personalized adaptive education course adapting to neurodiversity considerations in online learning.

Neurodiversity describes the idea that individuals experience and interact with the world around them in many different ways; there is not one “right” way of thinking, learning, and behaving. Neurodiversity describes the differences in brain function as strengths rather than as deficits. Neurodiversity refers to the diversity of all individuals, but it is often used in the context of individuals with cognitive or learning disabilities, such as autism spectrum disorder (ASD), attention deficit hyperactivity disorder (ADHD), dyslexia, dyscalculia, and dysgraphia.

### SUMMARY

Aspects of an embodiment of the present invention disclose a method, computer program product, and computer system for tailoring a set of course material of an online educational course to provide one or more learning supports necessary for a student with a neurodivergent-classified condition to succeed. A processor receives a request from a user to tailor a set of course material of an online educational course to provide one or more learning supports for the user. A processor identifies one or more neurodivergent needs of the user that prevent the user from completing the online educational course based on a first set of data gathered from a database. A processor observes the user complete an unmodified version of the online educational course in real-time to identify one or more additional neurodivergent needs of the user. A processor determines one or more preferences of the user based on the first set of data gathered and based on a set of observations made during the observing step, wherein the one or more preferences of the user include a preferred type of course material and a preferred order of receiving the set of course material. A processor generates a set of recommendations on how to tailor the set of course material of the online educational course. A processor creates a personalized user interface based on the set of recommendations for the user to access a tailored set of course material of the online educational course.

In some aspects of an embodiment of the present invention, the user is a student of the online educational course with a neurodivergent-classified condition.

In some aspects of an embodiment of the present invention, the first set of data gathered from the database includes a second set of data about a neurodivergent-classified condition of the user and a third set of data about one or more accommodation preferences of the user.

In some aspects of an embodiment of the present invention, the second set of data about the neurodivergent-classified condition of the user includes a limited attention consideration; a limited working memory consideration; a reading comprehension consideration; a fine motor skill consideration, and a multi-tasking ability consideration.

In some aspects of an embodiment of the present invention, a processor records one or more actions taken by the user as a first observation. A processor records an amount of time the user spends completing an activity in the set of course material of the online educational course as a second observation. A processor records an amount of time between two or more activities the user completes in the set of course material of the online educational course as a third observation. A processor derives a fourth set of data from the first observation, the second observation, and the third observation.

In some aspects of an embodiment of the present invention, the one or more actions of the user include at least one of interacting with the set of course material of the online educational course; starting, pausing, rewinding, and replaying a video of the set of course material of the online educational course; answering a checkpoint question of the set of course material of the online educational course; completing a lab exercise of the set of course material of the online educational course; and tracking an eye gaze of the user as the user completes the set of course material of the online educational course.

In some aspects of an embodiment of the present invention, the fourth set of data derived from the first observation, the second observation, and the third observation include at least one of an average attention span of the user; an average reading fluency of the user; a duration of shift in a short-term memory of the user after starting, pausing, rewinding, and replaying the video of the set of course material of the online educational course; and an average amount of time the user spends looking at a graphic.

In some aspects of an embodiment of the present invention, subsequent to observing the user complete the unmodified version of the online educational course in real-time to identify the one or more additional neurodivergent needs of the user, a processor tracks a degree of progress the user makes completing the unmodified version of the online educational course.

In some aspects of an embodiment of the present invention, a processor conducts a comparative analysis of the first set of data and the fourth set of data. A processor identifies one or more common behavioral patterns of the user through an application of a machine learning technique.

In some aspects of an embodiment of the present invention, the machine learning technique is a Naive Bayes technique, a K-means clustering technique, or a K-nearest neighbor technique.

In some aspects of an embodiment of the present invention, the set of recommendations is a combination of automatic modifications to the set of course material of the online education course, and wherein the combination of automatic modifications include an appearance-based modification, a material-based modification, and an operational-based modification.

In some aspects of an embodiment of the present invention, subsequent to creating the personalized user interface, a processor performs a final test on the tailored set of course material on one or more students with the one or more neurodivergent needs. A processor records a behavioral pattern of each student. A processor groups the one or more students based on a common behavioral pattern recorded. A processor refines the set of course material of the online education course.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps of an adaptive educational program, on a server within the distributed data processing environment of FIG. 1, in accordance with an embodiment of the present invention; and

FIG. 3 is a block diagram illustrating the components of the server within the distributed data processing environment of FIG. 1, in accordance with an embodiment of the present invention.

### DETAILED DESCRIPTION

Embodiments of the present invention recognize that an individual with neurodivergent features may experience learning-related difficulties including, but not limited to, difficulties with concentration and attention regulation, processing speed, fine motor skills, short-term and working memory, and time management. For example, an individual with ASD may have difficulty with time management and concentration, may struggle to cope with multiple tasks, and may have social and communication difficulties. An individual with ADHD may have difficulty with time management, concentration, attention, and self-regulation. An individual with dyslexia may have difficulty with reading fluently and may reverse letters and numbers. An individual with dyscalculia may have difficulty understanding arithmetic operations and solving math problems. An individual with dysgraphia may have difficulty with handwriting and motor coordination.

Embodiments of the present invention recognize that an individual with neurodivergent features may need online educational courses tailored to meet their needs. Embodiments of the present invention recognize that, currently, there exists commonly used assistive technology, such as screen readers and magnification, to aid individuals using computers. However, these features do not address accommodations for maximizing the educational value derived from online learning courses. Additionally, these features do not take into account the specific-personalized needs of the individual user, to create a more inclusive and enabling environment to learn. Therefore, embodiments of the present invention recognize the need for a system and method to tailor online educational courses to meet the needs of an individual with neurodivergent features.

Embodiments of the present invention provide a system and method to tailor a set of course material of an online educational course to provide one or more learning supports necessary for a student with a neurodivergent-classified condition to succeed in the online educational course. More specifically, embodiments of the present invention provide a system and method to determine the needs of an individual with neurodivergent features through data aggregation and direct observation of the individual's behavior when completing an unmodified version of the online educational course and to recommend a personalization of the materials required for the online educational course to offer a more adaptive and positive experience for the individual.

Embodiments of the present invention utilize a biopsychosocial model of neurodiversity to tailor the online educational course to meet the needs of the individual. A biopsychosocial model of neurodiversity is a model that views health as a result of biological, psychological, and social factors, where all three elements interact with each other. The biopsychosocial model of neurodiversity evolves work-related interventions and treatment to be more focused on adjusting the fit between the individual and the individual's environment versus treating a disability.

Embodiments of the present invention show that this system and method will help improve the efficacy of online educational courses, thus increasing the potential for success of individuals with neurodivergent features given their profile and environment.

Implementation of embodiments of the present invention may take a variety of forms, and exemplary implementation details are discussed subsequently with reference to the Figures.

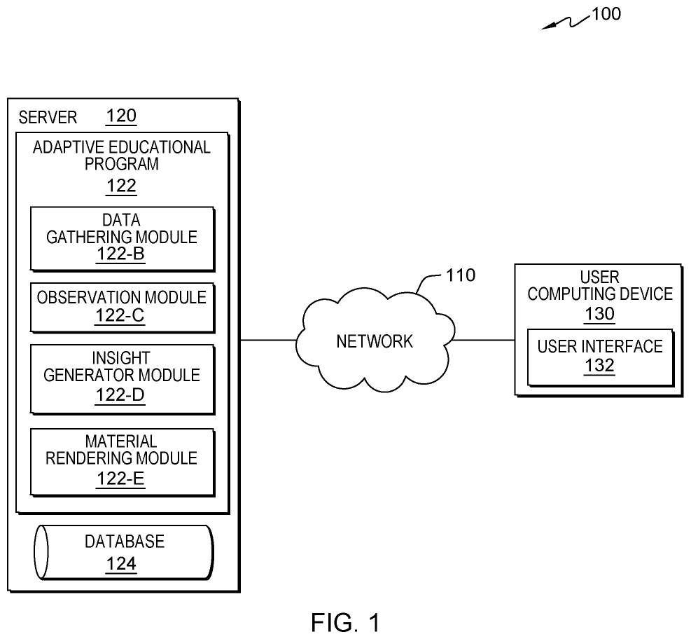

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regard to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

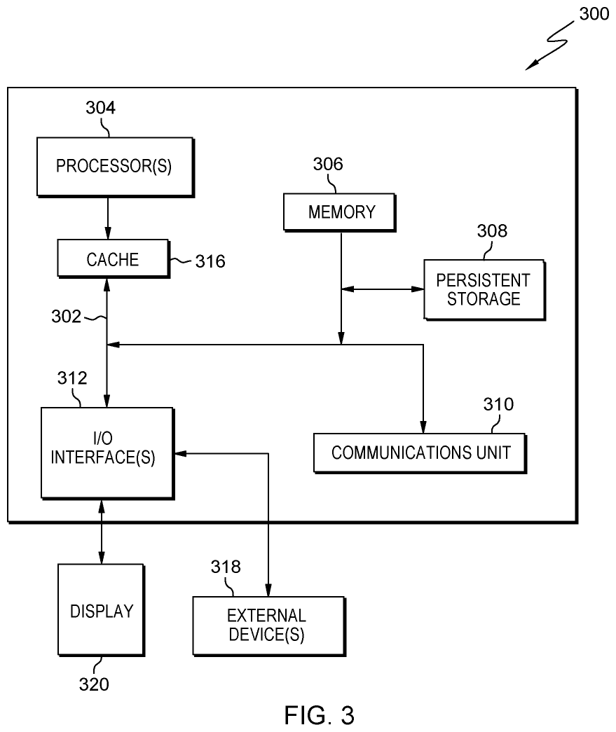

Server 120 operates to run adaptive educational program 122 and to send and/or store data in database 124. In an embodiment, server 120 can send data from database 124 to user computing device 130. In an embodiment, server 120 can receive data in database 124 from user computing device 130. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 3.

Adaptive educational program 122 operates to tailor a set of course material of an online educational course to provide one or more learning supports necessary for a student with a neurodivergent-classified condition to succeed in the online educational course. In the depicted embodiment, adaptive educational program 122 is a standalone program. In another embodiment, adaptive educational program 122 may be integrated into another software product, including, but not limited to, a classroom management software, a learning management educational software, and/or a student assessment software. In the depicted embodiment, adaptive educational program 122 includes data gathering module 122-B, observation module 122-C, insight generator module 122-D, and material rendering module 122-E. The modules represent the four stages of adaptive educational program 122. In stage one, data gathering module 122-B of adaptive educational program 122 operates to gather a set of data about a neurodivergent-classified condition of the user and a set of data about one or more accommodation preferences of the user. In stage two, observation module 122-C of adaptive educational program 122 operates to observe the user complete an unmodified version of an online educational course in real-time to identify one or more additional neurodivergent needs of the user. In stage three, insight generator module 122-D of adaptive educational program 122 operates to generate a set of recommendations on how to tailor a set of course material of the online educational course. In stage four, material rendering module 122-E of adaptive educational program 122 operates to create a personalized user interface based on the set of recommendations generated. In the depicted embodiment, adaptive educational program 122 resides on server 120. In another embodiment, adaptive educational program 122 may reside on user computing device 130 or on another computing device (not shown), provided that adaptive educational program 122 has access to network 110.

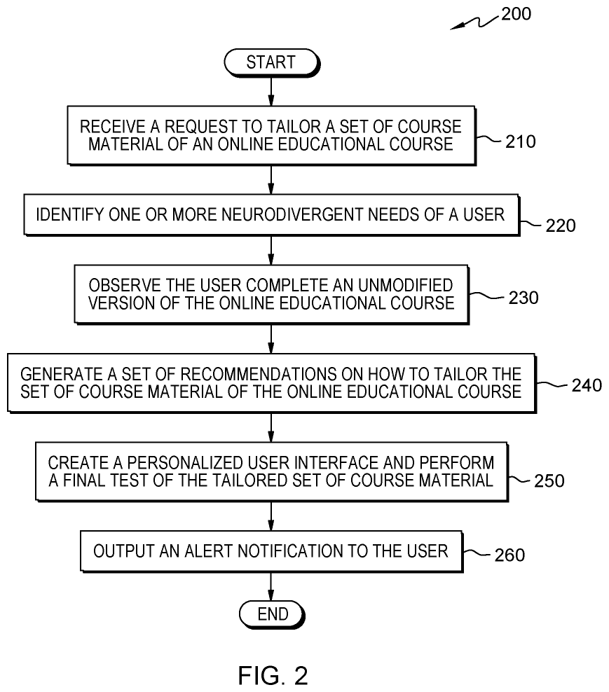

In an embodiment, the user of user computing device 130 registers with adaptive educational program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via adaptive educational program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124. The operational steps of adaptive educational program 122 are depicted and described in further detail with respect to FIG. 2.

Database 124 operates as a repository for data received, used, and/or generated by adaptive educational program 122. A database is an organized collection of data. Data includes, but is not limited to, information about user preferences (e.g., general user system settings such as alert notifications for user computing device 130); information about alert notification preferences; data about the user, including, but not limited to, a set of data about a neurodivergent-classified condition of the user and a set of data about one or more accommodation preferences of the user (e.g., the user's preferred type of course material from the data gathered and the user's preferred order of receiving the set of course material); observations made of the user; a set of data derived from the observations made of the user; a set of recommendations generated on how to tailor the set of course material of the online educational course; insights generated from a comparative analysis of the data gathered about the user and the observations made of the user; one or more common behavioral patterns of the user; and any other data received, used, and/or generated by adaptive educational program 122.

Database 124 can be implemented with any type of device capable of storing data and configuration files that can be accessed and utilized by server 120, such as a hard disk drive, a database server, or a flash memory. In an embodiment, database 124 is accessed by adaptive educational program 122 to store and/or to access data. In the depicted embodiment, database 124 resides on server 120. In another embodiment, database 124 may reside on another computing device, server, cloud server, or spread across multiple devices elsewhere (not shown) within distributed data processing environment 100, provided that adaptive educational program 122 has access to database 124.

The present invention may contain various accessible data sources, such as database 124, that may include personal and/or confidential company data, content, or information the user wishes not to be processed. Processing refers to any operation, automated or unautomated, or set of operations, such as collecting, recording, organizing, structuring, storing, adapting, altering, retrieving, consulting, using, disclosing by transmission, dissemination, or otherwise making available, combining, restricting, erasing, or destroying personal and/or confidential company data. Adaptive educational program 122 enables the authorized and secure processing of personal data.

Adaptive educational program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Adaptive educational program 122 provides information regarding personal and/or confidential data and the nature (e.g., type, scope, purpose, duration, etc.) of the processing. Adaptive educational program 122 provides the user with copies of stored personal and/or confidential company data. Adaptive educational program 122 allows the correction or completion of incorrect or incomplete personal and/or confidential data. Adaptive educational program 122 allows for the immediate deletion of personal and/or confidential data.

User computing device 130 operates to run user interface 132 through which a user can interact with adaptive educational program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with adaptive educational program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between adaptive educational program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from adaptive educational program 122 to a user via network 110. User interface 132 can also display or present alerts including information (such as graphics, text, and/or sound) sent from adaptive educational program 122 to a user via network 110. In an embodiment, user interface 132 is capable of sending and receiving data (i.e., to and from adaptive educational program 122 via network 110, respectively). Through user interface 132, a user can opt-in to adaptive educational program 122; create a user profile; set user preferences and alert notification preferences; input a request to tailor a set of course material of an online educational course to provide the user with one or more learning supports necessary for the user to succeed in the online educational course; input missing data about the user; receive and access the tailored set of course material; receive an alert notification; receive a request for feedback; and input feedback.

A user preference is a setting that can be customized for a particular user. A set of default user preferences are assigned to each user of adaptive educational program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of adaptive educational program 122.

FIG. 2 is a flowchart, generally designated 200, illustrating the operational steps for adaptive educational program 122, on server 120 within distributed data processing environment 100 of FIG. 1, in accordance with an embodiment of the present invention. In an embodiment, adaptive educational program 122 operates to tailor a set of course material of an online educational course to provide one or more learning supports necessary for a student with a neurodivergent-classified condition to succeed in the online educational course. It should be appreciated that the process depicted in FIG. 2 illustrates one possible iteration of the process flow, which may be repeated for each request received by adaptive educational program 122 to tailor a set of course material.

In step 210, adaptive educational program 122 receives a request from a user. In an embodiment, adaptive educational program 122 receives a request from a user of a user computing device (e.g., user computing device 130) via a user interface (e.g., user interface 132). In an embodiment, adaptive educational program 122 receives a request from a user to tailor a set of course material of an online educational course to provide the user with one or more learning supports necessary for the user to succeed in the online educational course. A user may be, but is not limited to, a student of an online educational course with a neurodivergent-classified condition. A neurodivergent-classified condition is a cognitive and/or learning disability. For example, a neurodivergent-classified condition may include, but is not limited to, autism spectrum disorder (ASD), attention deficit hyperactivity disorder (ADHD), dyslexia, dyscalculia, and dysgraphia). For example, a student has been diagnosed with ADHD. The student has been having difficulty concentrating during the student's online educational course. The student would benefit from guidance from adaptive educational program 122 with the student's set of course material for the student's online educational course. The student requests adaptive educational program 122 to tailor the student's set of course material from user computing device 130 via user interface 132.

In step 220, data gathering module 122-B of adaptive educational program 122 gathers data about the user. In an embodiment, responsive to receiving the request from the user, data gathering module 122-B of adaptive educational program 122 gathers data about the user. In an embodiment, data gathering module 122-B of adaptive educational program 122 gathers data about the user from a user profile of the user stored in a database (e.g., database 124). In an embodiment, if data gathering module 122-B of adaptive educational program 122 determines data is missing from the user profile of the user, data gathering module 122-B of adaptive educational program 122 requests the missing data from the user through the user computing device (e.g., user computing device 130) via the user interface (e.g., user interface 132). In an embodiment, data gathering module 122-B of adaptive educational program 122 enables the user to input the missing data through user computing device (e.g., user computing device 130) via the user interface (e.g., user interface 132). In an embodiment, data gathering module 122-B of adaptive educational program 122 analyzes the data gathered. In an embodiment, data gathering module 122-B of adaptive educational program 122 identifies one or more characteristics of the user that prevent the user from successfully completing the online education course (i.e., the one or more neurodivergent needs of the user) from the data gathered.

The data gathered may include, but is not limited to, a set of data about a neurodivergent-classified condition of the user and a set of data about one or more accommodation preferences of the user. The set of data about the neurodivergent classified condition of the user may include, but is not limited to, a limited attention consideration (i.e., the user's ability to maintain attention and focus); a limited working memory consideration (i.e., the user's ability to maintain information in the user's short-term memory at any given time, as well as the strength of the user's long-term memory); a reading comprehension consideration (i.e., the user's reading fluency and tendency to reverse letters and numbers); a fine motor skill consideration (i.e., the user's ability to type, the user's handwriting style, the user's dexterity, etc.), and a multi-tasking ability consideration (i.e., the user's ability to complete a plurality of tasks simultaneously). The one or more accommodation preferences of the user are one or more specific requests made by the user specifying how the user would like the set of course material of the online educational course tailored. The one or more accommodation preferences of the user may include, but are not limited to, a maximum video length (e.g., no video should exceed 8 minutes in length); subtitle provisioning; and multi-model learning style (i.e., custom material, such as an image, a set of text, and a tactile object that can be used simultaneously as a more engaging method than a standard talking head video).

In step 230, observation module 122-C of adaptive educational program 122 observes the user complete an unmodified version of the online educational course. In an embodiment, responsive to gathering data about the user, observation module 122-C of adaptive educational program 122 observes the user complete an unmodified version of the online educational course. In an embodiment, observation module 122-C of adaptive educational program 122 observes the user complete an unmodified version of the online educational course in real-time. In an embodiment, observation module 122-C of adaptive educational program 122 observes the user complete an unmodified version of the online educational course to identify one or more additional characteristics of the user that prevent the user from successfully completing the online education course (i.e., the one or more additional neurodivergent needs of the user). In an embodiment, observation module 122-C of adaptive educational program 122 records one or more actions taken by the user (i.e., a first observation) as the user completes the unmodified version of the online educational course. The one or more actions taken by the user may include, but are not limited to, interacting with the set of course material of the online educational course (e.g., interacting with an image, a set of text, and/or a tactile object); starting, pausing, rewinding, and replaying a video of the set of course material of the online educational course; answering a checkpoint question of the set of course material of the online educational course; completing a lab exercise of the set of course material of the online educational course; and tracking an eye gaze of the user as the user completes the set of course material of the online educational course.

In an embodiment, observation module 122-C of adaptive educational program 122 records an amount of time the user spends completing each activity of the online educational course (i.e., a second observation). In an embodiment, observation module 122-C of adaptive educational program 122 records an amount of time between two or more activities the user completes in the set of course material of the online educational course (i.e., a third observation). In an embodiment, observation module 122-C of adaptive educational program 122 derives a set of data from the observations of the user made by observation module 122-C of adaptive educational program 122. The set of data derived from the observations of the user may include, but is not limited to, an average attention span of the user; an average reading fluency of the user; a duration of shift in a short-term memory of the user after starting, pausing, rewinding and replaying the video of the set of course material of the online educational course; and an average amount of time the user spends looking at a graphic.

In an embodiment, observation module 122-C of adaptive educational program 122 determines one or more preferences of the user. In an embodiment, observation module 122-C of adaptive educational program 122 determines the user's preferred type of course material from the data gathered (i.e., in step 220) and from the observations made (i.e., in step 230) (e.g., images, video, text, and/or audio). In an embodiment, observation module 122-C of adaptive educational program 122 determines the user's preferred order of receiving the set of course material from the data gathered (i.e., in step 220) and from the observations made (i.e., in step 230) (e.g., first text then images followed by videos or vice versa).

In an embodiment, observation module 122-C of adaptive educational program 122 continually observes the user during an entire iteration of the process flow. In an embodiment, observation module 122-C of adaptive educational program 122 tracks a degree of progress the user makes completing the unmodified version of the online educational course. In an embodiment, observation module 122-C of adaptive educational program 122 tracks a degree of progress the user makes by continually gathering data about the user's performance. In another embodiment, observation module 122-C of adaptive educational program 122 tracks a degree of progress the user makes by measuring how well the user understands the material of the online educational course. In an embodiment, observation module 122-C of adaptive educational program 122 tracks the user's rate of completion of the unmodified version of the online educational course. In an embodiment, observation module 122-C of adaptive educational program 122 compares the user's rate of completion of the unmodified version of the online educational course to one or more students in the online educational course.

In step 240, insight generator module 122-D of adaptive educational program 122 generates a set of recommendations on how to tailor the set of course material of the online educational course. In an embodiment, responsive to completing the observation period, insight generator module 122-D of adaptive educational program 122 generates a set of recommendations on how to tailor the set of course material of the online educational course. In an embodiment, insight generator module 122-D of adaptive educational program 122 generates a set of recommendations on how to tailor the set of course material of the online educational course to provide the user with the one or more learning supports necessary for the user to succeed in the online educational course (i.e., to improve neurodiverse learner performance).

In an embodiment, insight generator module 122-D of adaptive educational program 122 conducts a comparative analysis of the set of data gathered about the user (i.e., the set of data gathered by data gathering module 122-B of adaptive educational program 122) and the set of observations made of the user (i.e., the set of observations made by observation module 122-C of adaptive educational program 122). In an embodiment, insight generator module 122-D of adaptive educational program 122 identifies one or more common behavioral patterns of the user through an application of a machine learning technique. The machine learning technique may be, but is not limited to, a Naïve Bayes technique, a K-means clustering technique, and a K-nearest neighbor technique.

The Naïve B ayes machine learning technique is a machine learning algorithm used to classify a set of text, an image, and a set of time series data. The Naïve Bayes machine learning technique can also be used to classify the set of course material of the online educational course, including scripts, diagrams, and video length.

The K-means clustering machine learning technique is a partitioning method that assigns each object in a data set to a K cluster, based on the point's similarity to other objects in the K cluster. For example, the K-means clustering machine learning technique may show a tendency to pause, rewind, and replay video segments.

The K-nearest neighbor (kNN) machine learning technique is a classification algorithm used to learn from “training” data. The kNN machine learning technique categorizes new data based on the similarity of the new data to the training data. The kNN machine learning technique assigns a label to new objects based on the label of the majority of its closest objects. The kNN algorithm also groups commonly found course interaction patterns across multiple learning instances, detecting, for example, how students with similar neurodiverse requirements interact with a set of course material.

In an embodiment, insight generator module 122-D of adaptive educational program 122 generates insights from the comparative analysis. The insights generated are about how the user interacts with the set of course material of the online educational course. The insights generated are used as inputs in step 250.

In step 250, material rendering module 122-E of adaptive educational program 122 creates a personalized user interface. In an embodiment, responsive to generating the set of recommendations on how to tailor the set of course material of the online educational course, material rendering module 122-E of adaptive educational program 122 creates a personalized user interface. In an embodiment, material rendering module 122-E of adaptive educational program 122 creates a personalized user interface using the insights generated in step 240. In an embodiment, material rendering module 122-E of adaptive educational program 122 creates a personalized user interface through a series of testing iterations.

In an embodiment, material rendering module 122-E of adaptive educational program 122 presents the personalized user interface to the user through user computing device 130 via user interface 132. In an embodiment, material rendering module 122-E of adaptive educational program 122 enables the user to access the tailored set of course material through user computing device 130 via user interface 132.

In several embodiments, step 250 involves a combination of automatic modifications to the set of course material of the online educational course. The combination of automatic modifications may include, but are not limited to, an appearance-based modification, a material-based modification, and an operational-based modification.

Appearance-based modifications may include, but are not limited to, an automatic modification of an image (e.g., altering a magnification level on an image, cropping an image, and/or hiding a non-informative image); an automatic modification of a text (e.g., customizing the color of the text, the font size of the text, the font style of the text, the spacing of the text, the alignment of the text, and/or the line height of the text); an automatic modification of the layout (e.g., simplifying the structure of the layout and the navigation of the course materials; applying color filters to the entire course content (i.e., inverting the colors, changing the dark/light contrast, and/or desaturating the colors); and/or highlighting the URLs); an automatic motion reduction on the screen (e.g., eliminating or providing a simple and clear option for the student to control any automated updating, scrolling, blinking, animation, and/or movement on the screen that is considered non-essential functionality to reduce the risk of distraction); and an automatic modification of the cursor (e.g., increasing or decreasing the size of the cursor, altering the color of the cursor, and/or implementing a reading mask or a reading guide for the cursor).

Material-based modifications may include, but are not limited to, an automatic modification of the timing (e.g., changing the length of a video's duration into a plurality of videos or articles to not exceed a threshold length of time, removing time limit constraints automatically and/or allowing the user to alter time limits, and/or providing progress indicators to aid the user in time management while providing a clear indication of completion status) and/or an automatic modification of content (e.g., modifying the order of the course materials to reduce cognitive overload on students and/or providing definitions of abbreviations and nonliteral word usage).

Operational-based modifications may include, but are not limited to, an automatic control to pause, resume, and/or replay a video with a plurality of simple control methods (e.g., keyboard shortcuts, voice control, eye tracking, and/or note-taking tracking, wherein the note-taking tracking would be achieved by providing a clearly indicated note-taking space in the window. The system would analyze the students notes as they are written and compare the notes to the content presented in the video. This would allow the system to align the course video with the note-taking by pausing the content to allow the student to finish taking notes for the section and resume when the note-taking finishes, or by replaying the previous 30 second interval to synchronize the video with the notes. It would also offer an auto-complete feature, a suggested word or phrase completion option; an autogenerated transcript with guided tracking (i.e., A split screen view, with the option of opening each view in a separate tab or window, which contains a module on one side and an audio transcript of the module, including any visual aids/graphics presented in the module, on the other side, would be provided. The transcript of the module includes a guided reading and tracking feature that highlights the content of the transcript as it is spoken or referred to in the video.); a smart note-taking assistant (e.g., A set of notes or a text summary would be autogenerated based on the module content when the user reaches the end of the section so the user is able to focus solely on the material being presented and has resources to refer back to later. The user can then choose to alter the reading-level of the set of notes or the text summary to reduce complexity of the language used.); an automatic break at set intervals (e.g., Automatic break prompts would be incorporated throughout the course after a certain threshold of time has been met. The system would alert the user that the user has been working for X amount of time and then would ask the user if the user would like to take a break. If the user opts to take the break, it would be timed. When completed, an alert would be provided to the user to notify the user that the user's break has ended and the user can resume course work.); a multi-modal learning style that provides custom material such as images, text, tactile objects that can be used simultaneously as a more engaging and personalized method than standard talking head videos; a subtitle provision; an alternative navigation method (e.g., eye tracking sensory technology or voice control via speech recognition technology, as an alternative for the user to control and navigate the interface); and/or an alternative keyboard access method (e.g., eye tracking sensory technology with a virtual keyboard as an alternative method for the student to produce input for interactive portions of the course material or speech-to-text technology to produce input by the user).

In an embodiment, material rendering module 122-E of adaptive educational program 122 continually monitors the user complete the tailored set of course material. In an embodiment, responsive to material rendering module 122-E of adaptive educational program 122 detecting a need for one or more additional learning supports, material rendering module 122-E of adaptive educational program 122 adjusts the tailored set of course material.

In an embodiment, material rendering module 122-E of adaptive educational program 122 performs a final testing on the tailored set of course material on one or more students with one or more neurodivergent needs. In an embodiment, material rendering module 122-E of adaptive educational program 122 records the behavioral patterns of each student. In an embodiment, material rendering module 122-E of adaptive educational program 122 analyzes the behavioral patterns of each student. In an embodiment, material rendering module 122-E of adaptive educational program 122 groups the one or more students based on a common behavioral pattern recorded (e.g., replaying videos or pausing frequently to take notes). In an embodiment, material rendering module 122-E of adaptive educational program 122 send the common behavioral pattern recorded to insight generator module 122-D of adaptive educational program 122 (i.e., back to step 240) to further refine the set of course material.

In step 260, adaptive educational program 122 outputs an alert notification to the user. In an embodiment, responsive to creating the personalized user interface, adaptive educational program 122 outputs an alert notification to the user. In an embodiment, adaptive educational program 122 outputs an alert notification to the user via user interface 132 of user computing device 130. The alert notification may include, but is not limited to, one or more modifications to the set of course material of the online educational course (e.g., one or more additional learning supports).

For example, student A struggles to stay focused and therefore gets distracted very easily. This causes student A to either rewind a video multiple times to listen to what was said again or to move along with the course without reviewing what student A missed. For student A to effectively learn from this type of course material, student A needs to regularly pause the video to take notes, rewind the video, and then resume playback of the video. Program 122 tailors the set of course material of the online educational course to incorporate automatic pause, rewind, and resume functionality aligned to student A's note taking abilities.

In a second example, student B has fine motor difficulties and, therefore, struggles to take notes without multiple errors. Student B's fine motor difficulties cause student B to take longer to take notes than other students or to move along without taking any notes. Program 122 tailors the set of course material of the online educational course to incorporate voice control with speech recognition. With the incorporation of voice control, student B will be able to type notes and navigate the user interface more easily. This will also eliminate the need for student B to use student B's hands to complete the tasks. Program 122 may also tailor the set of course material of the online educational course to incorporate eye tracking sensory technology to control both navigating the user interface and typing commands with a virtual keyboard.

In a third example, student C suffers from a biopsychosocial condition. Student C has difficulties with memory, fatigue, pain and concentration. Student C is taking a course that requires student C to write summaries of the content at the end of a section. Student C's summaries are unfocused and rambling. Student C's summaries are also illegible because student C is often fatigued. Program 122 tailors the set of course material of the online educational course to provide automatic summaries of each section of the course material. By automatically summarizing each section of the course material, student C will be able to focus on what was discussed during the lecture. Additionally, by automatically summarizing each section of the course material, student C will be able to better manage student C's time knowing that student C's notes will be generated for student C.

FIG. 3 is a block diagram illustrating the components of computing device 300, suitable for server 120 running adaptive educational program 122 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

As depicted, computing device 300 includes communications fabric 302, processor(s) 304, memory 306, persistent storage 308, communications unit 310, input/output (I/O) interface(s) 312, and cache 316. Communications fabric 302 provides communications between memory 306, cache 316, persistent storage 308, input/output (I/O) interface(s) 312, and communications unit 310. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a cross switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Program instructions and data (e.g., software and data) used to practice embodiments of the present invention may be stored in persistent storage 308 and in memory 306 for execution by one or more of the respective processor(s) 304 via cache 316. In an embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308. Software and data can be stored in persistent storage 308 for access and/or execution by one or more of the respective processor(s) 304 via cache 316. With respect to user computing device 130, software and data includes user interface 132. With respect to server 120, software and data includes adaptive educational program 122.

Communications unit 310, in these examples, provides for communications with other data processing systems or devices. In these examples, communications unit 310 includes one or more network interface cards. Communications unit 310 may provide communications through the use of either or both physical and wireless communications links. Program instructions and data (e.g., software and data) used to practice embodiments of the present invention may be downloaded to persistent storage 308 through communications unit 310.

I/O interface(s) 312 allows for input and output of data with other devices that may be connected to each computer system. For example, I/O interface(s) 312 may provide a connection to external device(s) 318, such as a keyboard, a keypad, a touch screen, and/or some other suitable input device. External device(s) 318 can also include portable computer readable storage media, such as, for example, thumb drives, portable optical or magnetic disks, and memory cards. Program instructions and data (e.g., software and data) used to practice embodiments of the present invention can be stored on such portable computer readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a request from a user to tailor a set of course material of an online educational course to provide one or more learning supports for the user;
identifying, by the one or more processors, one or more neurodivergent needs of the user that prevent the user from completing the online educational course based on a first set of data gathered from a database;
observing, by the one or more processors, the user complete an unmodified version of the online educational course in real-time to identify one or more additional neurodivergent needs of the user;
determining, by the one or more processors, one or more preferences of the user based on the first set of data gathered and based on a set of observations made during the observing step, wherein the one or more preferences of the user include a preferred type of course material and a preferred order of receiving the set of course material;
generating, by the one or more processors, a set of recommendations on how to tailor the set of course material of the online educational course; and
creating, by the one or more processors, a personalized user interface based on the set of recommendations for the user to access a tailored set of course material of the online educational course.

2. The computer-implemented method of claim 1, wherein the user is a student of the online educational course with a neurodivergent-classified condition.

3. The computer-implemented method of claim 1, wherein the first set of data gathered from the database includes a second set of data about a neurodivergent-classified condition of the user and a third set of data about one or more accommodation preferences of the user.

4. The computer-implemented method of claim 3, wherein the second set of data about the neurodivergent-classified condition of the user includes a limited attention consideration; a limited working memory consideration; a reading comprehension consideration; a fine motor skill consideration, and a multi-tasking ability consideration.

5. The computer-implemented method of claim 1, wherein observing the user complete the unmodified version of the online educational course in real-time to identify the one or more additional neurodivergent needs of the user further comprises:
recording, by the one or more processors, one or more actions taken by the user as a first observation;
recording, by the one or more processors, an amount of time the user spends completing an activity in the set of course material of the online educational course as a second observation;
recording, by the one or more processors, an amount of time between two or more activities the user completes in the set of course material of the online educational course as a third observation; and
deriving, by the one or more processors, a fourth set of data from the first observation, the second observation, and the third observation.

6. The computer-implemented method of claim 5, wherein the one or more actions of the user include at least one of interacting with the set of course material of the online educational course; starting, pausing, rewinding, and replaying a video of the set of course material of the online educational course; answering a checkpoint question of the set of course material of the online educational course; completing a lab exercise of the set of course material of the online educational course; and tracking an eye gaze of the user as the user completes the set of course material of the online educational course.

7. The computer-implemented method of claim 5, where the fourth set of data derived from the first observation, the second observation, and the third observation include at least one of an average attention span of the user; an average reading fluency of the user; a duration of shift in a short-term memory of the user after starting, pausing, rewinding, and replaying the video of the set of course material of the online educational course; and an average amount of time the user spends looking at a graphic.

8. The computer-implemented method of claim 1, further comprising:
subsequent to observing the user complete the unmodified version of the online educational course in real-time to identify the one or more additional neurodivergent needs of the user, tracking, by the one or more processors, a degree of progress the user makes completing the unmodified version of the online educational course.

9. The computer-implemented method of claim 1, wherein generating the set of recommendations on how to tailor the set of course material of the online educational course further comprises:
conducting, by the one or more processors, a comparative analysis of the first set of data and the fourth set of data; and
identifying, by the one or more processors, one or more common behavioral patterns of the user through an application of a machine learning technique.

10. The computer-implemented method of claim 9, wherein the machine learning technique is a Naive Bayes technique, a K-means clustering technique, or a K-nearest neighbor technique.

11. The computer-implemented method of claim 1, wherein the set of recommendations is a combination of automatic modifications to the set of course material of the online education course, and wherein the combination of automatic modifications include an appearance-based modification, a material-based modification, and an operational-based modification.

12. The computer-implemented method of claim 1, further comprising:
subsequent to creating the personalized user interface, performing, by the one or more processors, a final test on the tailored set of course material on one or more students with the one or more neurodivergent needs;
recording, by the one or more processors, a behavioral pattern of each student;
grouping, by the one or more processors, the one or more students based on a common behavioral pattern recorded; and
refining, by the one or more processors, the set of course material of the online education course.

13. A computer program product comprising:
one or more computer readable storage media and program instructions stored on the one or more computer readable storage media, the program instructions comprising:
program instructions to receive a request from a user to tailor a set of course material of an online educational course to provide one or more learning supports for the user;
program instructions to identify one or more neurodivergent needs of the user that prevent the user from completing the online educational course based on a first set of data gathered from a database;
program instructions to observe the user complete an unmodified version of the online educational course in real-time to identify one or more additional neurodivergent needs of the user;
program instructions to determine one or more preferences of the user based on the first set of data gathered and based on a set of observations made during the observing step, wherein the one or more preferences of the user include a preferred type of course material and a preferred order of receiving the set of course material;
program instructions to generate a set of recommendations on how to tailor the set of course material of the online educational course; and
program instructions to create a personalized user interface based on the set of recommendations for the user to access a tailored set of course material of the online educational course.

14. The computer program product of claim 13, wherein observing the user complete the unmodified version of the online educational course in real-time to identify the one or more additional neurodivergent needs of the user further comprises:
program instructions to record one or more actions taken by the user as a first observation;
program instructions to record an amount of time the user spends completing an activity in the set of course material of the online educational course as a second observation;
program instructions to record an amount of time between two or more activities the user completes in the set of course material of the online educational course as a third observation; and
program instructions to derive a fourth set of data from the first observation, the second observation, and the third observation.

15. The computer program product of claim 13, further comprising:
subsequent to observing the user complete the unmodified version of the online educational course in real-time to identify the one or more additional neurodivergent needs of the user, program instructions to track a degree of progress the user makes completing the unmodified version of the online educational course.

16. The computer program product of claim 13, wherein generating the set of recommendations on how to tailor the set of course material of the online educational course further comprises:
program instructions to conduct a comparative analysis of the first set of data and the fourth set of data; and
program instructions to identify one or more common behavioral patterns of the user through an application of a machine learning technique.

17. A computer system comprising:
one or more computer processors;
one or more computer readable storage media;
program instructions collectively stored on the one or more computer readable storage media for execution by at least one of the one or more computer processors, the stored program instructions comprising:
program instructions to receive a request from a user to tailor a set of course material of an online educational course to provide one or more learning supports for the user;
program instructions to identify one or more neurodivergent needs of the user that prevent the user from completing the online educational course based on a first set of data gathered from a database;
program instructions to observe the user complete an unmodified version of the online educational course in real-time to identify one or more additional neurodivergent needs of the user;
program instructions to determine one or more preferences of the user based on the first set of data gathered and based on a set of observations made during the observing step, wherein the one or more preferences of the user include a preferred type of course material and a preferred order of receiving the set of course material;
program instructions to generate a set of recommendations on how to tailor the set of course material of the online educational course; and
program instructions to create a personalized user interface based on the set of recommendations for the user to access a tailored set of course material of the online educational course.

18. The computer system of claim 17, wherein observing the user complete the unmodified version of the online educational course in real-time to identify the one or more additional neurodivergent needs of the user further comprises:
program instructions to record one or more actions taken by the user as a first observation;
program instructions to record an amount of time the user spends completing an activity in the set of course material of the online educational course as a second observation;
program instructions to record an amount of time between two or more activities the user completes in the set of course material of the online educational course as a third observation; and
program instructions to derive a fourth set of data from the first observation, the second observation, and the third observation.

19. The computer system of claim 17, further comprising:
subsequent to observing the user complete the unmodified version of the online educational course in real-time to identify the one or more additional neurodivergent needs of the user, program instructions to track a degree of progress the user makes completing the unmodified version of the online educational course.

20. The computer system of claim 17, wherein generating the set of recommendations on how to tailor the set of course material of the online educational course further comprises:
program instructions to conduct a comparative analysis of the first set of data and the fourth set of data; and
program instructions to identify one or more common behavioral patterns of the user through an application of a machine learning technique.
